(19) United States
(12) Patent Application Publication
(10) Pub. No.: US 2026/0274325 A1
(43) Pub. Date: Sep. 17, 2026

(54) STEERING COLUMN DEVICE

(71) Applicant: TOYO DENSO KABUSHIKI KAISHA, Tokyo (JP)

(72) Inventors: Naoto OHTSUKA, Tsurugashima-shi (JP); Masato KIKUCHI, Tsurugashima-shi (JP)

(21) Appl. No.: 19/564,583

(22) Filed: Mar. 12, 2026

(30) Foreign Application Priority Data
Mar. 17, 2025 (JP) 2025-042533

(51) Int. Cl. B62D 1/183; B62D 1/181

(52) U.S. Cl. CPC B62D 1/183; B62D 1/181

(57) ABSTRACT

A steering column device capable of avoiding interference between an operation lever and an instrument panel during storage of a steering wheel. The steering column is movable forward and backward between a protruding position and a storage position relative to the instrument panel. A lever unit provided on the steering column includes an operation lever, and changes its posture relative to the steering column between a use posture and a non-use posture. The distance of a distal end position of the operation lever from the rotation center of the steering wheel is shorter when the lever unit is in the non-use posture than when the lever unit is in the use posture. When the steering column moves from the protruding position to the storage position, the lever unit changes from the use posture to the non-use posture to avoid interference between the operation lever and the instrument panel.

### BACKGROUND OF THE INVENTION

### Field of the Invention

The present disclosure relates to steering column devices.

### Description of the Related Art

There has been known an approach, when a steering wheel of a vehicle is not in use, to store the steering wheel in a predetermined storage position in order to increase space at a driver's feet. For example, in a technology disclosed in Japanese Patent No. 7077729, a steering wheel is completely stored in an instrument panel (dashboard). A technology disclosed in Japanese Patent No. 4547802 adopts a simple storage structure in which a part of a steering wheel is stored in an instrument panel.

When such a steering wheel is stored in its storage position, a steering column is usually stored in the storage position as an integral unit with the steering wheel. A typical steering column is provided with an operation lever projecting in the left-right direction. Therefore, when considering storage of a steering wheel in an instrument panel, it would be desirable to devise a structure that prevents the operation lever from interfering with the instrument panel. However, Japanese Patent No. 7077729 and Japanese Patent No. 4547802 do not refer to avoidance of interference between an operation lever and an instrument panel.

### SUMMARY OF THE INVENTION

The present disclosure provides steering column devices capable of avoiding interference between an operation lever and an instrument panel when a steering wheel is stored in its storage position.

A steering column device according to one aspect of the disclosure includes a steering column and a lever unit. The steering column is movable forward and backward between a protruding position and a storage position relative to an instrument panel. The lever unit is provided on the steering column and includes an operation lever. The lever unit is configured to change its posture relative to the steering column between a use posture and a non-use posture. A distance of a distal end position of the operation lever from a rotation center of a steering wheel is shorter when the lever unit is in the non-use posture than when the lever unit is in the use posture. When the steering column moves from the protruding position to the storage position, the lever unit changes from the use posture to the non-use posture to avoid interference between the operation lever and the instrument panel.

The above configuration ensures that interference between the operation lever and the instrument panel is avoided when the steering wheel is stored in its storage position in the steering column device.

Further features of the present invention will become apparent from the following description of exemplary embodiments with reference to the attached drawings.

### BRIEF DESCRIPTION OF THE DRAWINGS

FIG. 1 is a schematic perspective view of a steering column device.

FIG. 2 is a block diagram of the steering column device.

FIGS. 3A to 3C are perspective views each illustrating the vicinity of an operation lever in a first configuration example.

FIGS. 4A to 4C are perspective views each illustrating the vicinity of an operation lever in a second configuration example.

FIG. 5 is a perspective view illustrating the vicinity of an operation lever in a third configuration example.

FIGS. 6A to 6C are perspective views each illustrating the vicinity of an operation lever in a fourth configuration example.

FIG. 7 is a perspective view illustrating the vicinity of an operation lever in a fifth configuration example.

FIGS. 8A and 8B are schematic top views of a steering column device according to a second embodiment.

FIGS. 9A and 9B are perspective views each illustrating the vicinity of a lever unit in a sixth configuration example.

FIGS. 10A and 10B are perspective views each illustrating the vicinity of a lever unit in a seventh configuration example.

FIGS. 11A and 11B are perspective views each illustrating the vicinity of a lever unit in an eighth configuration example.

FIGS. 12A and 12B are perspective views each illustrating the vicinity of a lever unit in a ninth configuration example.

FIGS. 13A and 13B are enlarged perspective views of the vicinity of a second member in the eighth and ninth configuration examples.

### DESCRIPTION OF THE EMBODIMENTS

Hereinafter, embodiments of the present technology will be described with reference to the drawings.

### First Embodiment

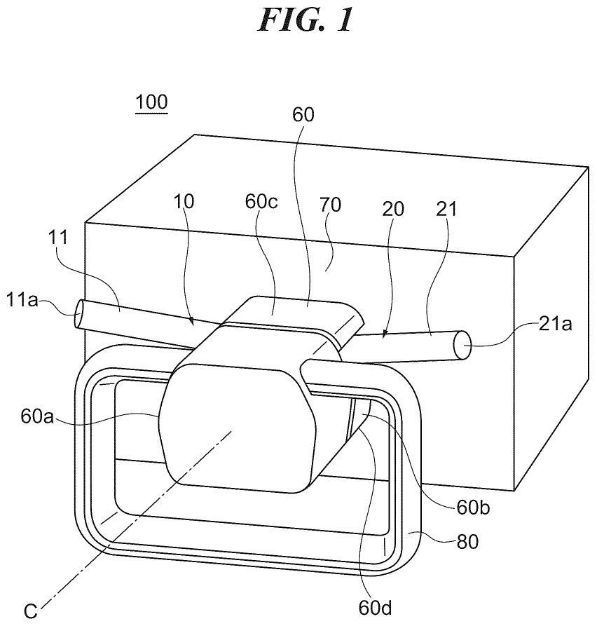

FIG. 1 is a schematic perspective view of a steering column device according to a first embodiment of the present disclosure. A steering column device 100 is disposed on an instrument panel 70 in a vehicle such as an automobile. The steering column device 100 includes a steering column 60. Lever units 10 and 20 are provided on a left side portion and a right side portion of the steering column 60, respectively. A steering wheel 80 is disposed in the vicinity of the distal end of the steering column 60. The steering wheel 80 is rotatable about a rotation center C.

The steering column 60 protrudes from the instrument panel 70 during use. As viewed from an occupant, the steering column 60 includes a left side face 60a, a right side face 60b, an upper face 60c, and a bottom face 60d.

An operation lever 11 of the lever unit 10 and an operation lever 21 of the lever unit 20 are used by an occupant for various control operations during manual driving, such as directional indication, lighting switching, and gear shifting. To increase space at a driver's feet when the steering wheel 80 is not in use (e.g., during automatic driving), the steering column device 100 employs a simple storage structure in which the steering wheel 80 approaches or abuts against the instrument panel 70.

Therefore, the steering column 60 is configured to move integrally with the steering wheel 80 in the axial direction of the rotation center C, thereby being movable forward and backward between a protruding position and a storage position relative to the instrument panel 70. FIG. 1 illustrates the steering column 60 at the protruding position. At the storage position, most of the steering column 60 is stored within the instrument panel 70.

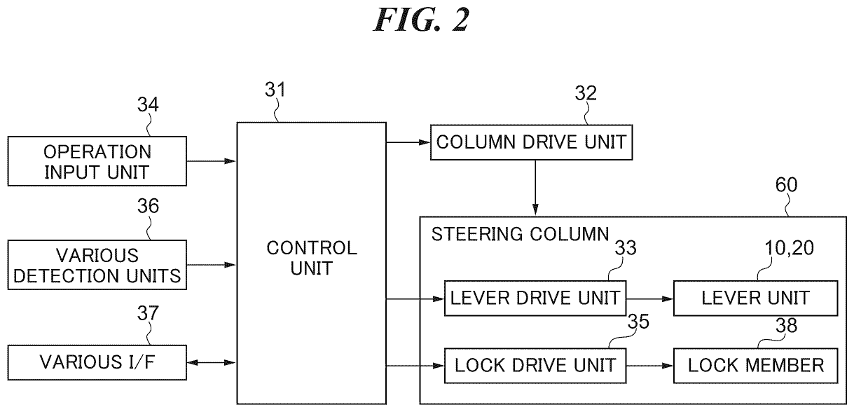

FIG. 2 is a block diagram of the steering column device 100.

The steering column device 100 includes a control unit 31, a column drive unit 32, a lever drive unit 33, an operation input unit 34, a lock drive unit 35, various detection units 36, various I/Fs 37, and a lock member 38.

The control unit 31 includes a processor and a memory (both are not illustrated), and controls the entire steering column device 100. This control is implemented by the processor executing a program stored in the memory.

The operation input unit 34 is configured to receive operation inputs from an occupant and transmit the received information to the control unit 31. The various detection units 36 are configured to detect different conditions in the vehicle and transmit the detected information to the control unit 31. The various I/Fs 37 are communicable with an external communication device (which is not illustrated) in a wireless or wired manner. The communication standard used here is not specified. The lock drive unit 35 is configured to drive (actuate) the lock member 38. It should be noted that in the present embodiment, the lock drive unit 35 and the lock member 38 are not essential.

The lever units 10 and 20 are configured to change their posture relative to the steering column 60 between a use posture and a non-use posture. The lever drive unit 33 is configured to drive (accentuate) at least a part of each of the lever units 10 and 20 to change the posture of each of the lever units 10 and 20. The lever drive unit 33 is, for example, a motor. The lever drive unit 33 may be provided separately for each of the lever units 10 and 20, or one lever drive unit 33 may be provided in common for the lever units 10 and 20.

The column drive unit 32 is configured to move the steering column 60 forward and backward between the protruding position and the storage position in the axial direction of the rotation center C. The column drive unit 32 is, for example, a motor.

In response to acquiring an instruction to move the steering column 60 to the storage position from the operation input unit 34 or the like, the control unit 31 controls the column drive unit 32 to move the steering column 60 to the storage position. When causing the steering column 60 to move to the storage position, the control unit 31 controls the lever drive unit 33 to change the lever units 10 and 20 to the non-use posture.

Here, the lever units 10 and 20 are configured such that the distance of the positions of a distal end portions 11a and 21a (see FIG. 1) of the operation levers 11 and 21 from the rotation center C is shorter in the non-use posture than in the use posture. As a result, when the steering column 60 moves from the protruding position to the storage position, the lever units 10 and 20 change from the use posture to the non-use posture. This avoids interference between the operation levers 11 and 21 and the instrument panel 70.

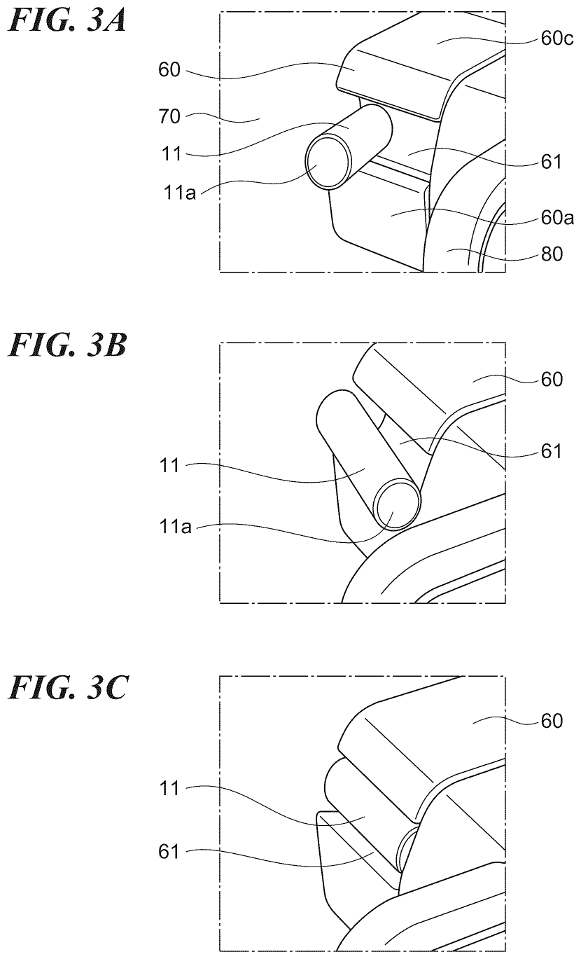

Referring to FIGS. 3A to 7, a description is given of configuration examples of the steering column device 100 in which interference between the operation levers 11 and 21 and the instrument panel 70 is avoided by the lever units 10 and 20 changing to the non-use posture. FIGS. 3A to 7 are partial front perspective views of the steering column device 100. The steering column device 100 may adopt any of these configuration examples. Since the configurations of the lever units 10 and 20 regarding posture changes are common except that they are bilaterally symmetrical, the posture change of the operation lever 11 of the lever unit 10 will be mainly described with reference to FIGS. 3A to 7.

FIGS. 3A, 3B, and 3C are perspective views each illustrating the vicinity of the operation lever 11 in a first configuration example. FIG. 3A illustrates the operation lever 11 in the use posture, FIG. 3B illustrates the posture of the operation lever 11 on the way from the use posture to the non-use posture, and FIG. 3C illustrates the operation lever 11 in the non-use posture.

The operation lever 11 is configured to be rotatable between the state illustrated in FIG. 3A and the state illustrated in FIG. 3C. A storage space 61 is provided on the left side face 60a of the steering column 60. The storage space 61 is, for example, a recess corresponding to the shape of the operation lever 11.

The operation lever 11 in the non-use posture is tilted in a direction in which the distal end portion 11a of the operation lever 11 approaches the left side face 60a (counterclockwise direction as viewed from above the steering column device 100). As a result, the operation lever 11 in the non-use posture is stored in the storage space 61. It is not essential for the operating lever 11 to be fully stored in the storage space 61. Even if at least part of the operation lever 11 enters the storage space 61, this is also referred to as being stored. The same applies to other configuration examples.

When the operation lever 11 is stored in the storage space 61, the distance of the distal end portion 11a of the operation lever 11 from the rotation center C becomes shorter than when the operation lever 11 is in the use posture. This ensures that the operation lever 11 does not interfere with the instrument panel 70 when the steering column 60 moves to the storage position.

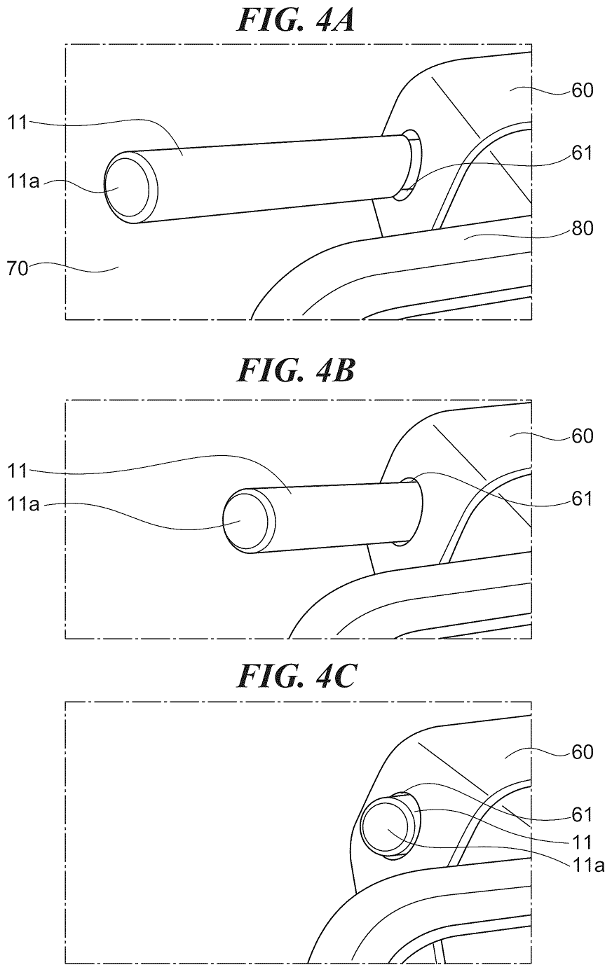

FIGS. 4A, 4B, and 4C are perspective views each illustrating the vicinity of the operation lever 11 in a second configuration example. FIG. 4A illustrates the operation lever 11 in the use posture, FIG. 4B illustrates the posture of the operation lever 11 on the way between the use posture and the non-use posture, and FIG. 4C illustrates the operation lever 11 in the non-use posture.

The operation lever 11 is configured to be movable forward and backward in the longitudinal direction of the operation lever 11. The storage space 61 provided on the left side face 60a of the steering column 60 is a hole capable of storing the operation lever 11.

The operation lever 11 in the non-use posture is retracted and stored in the storage space 61. When the operation lever 11 is stored in the storage space 61, the distal end portion 11a of the operation lever 11 approaches the rotation center C. This reduces the amount of protrusion of the operation lever 11 in the radial direction around the rotation center C. Therefore, when the steering column 60 moves to the storage position with the operation lever 11 in this state, the operation lever 11 does not interfere with the instrument panel 70.

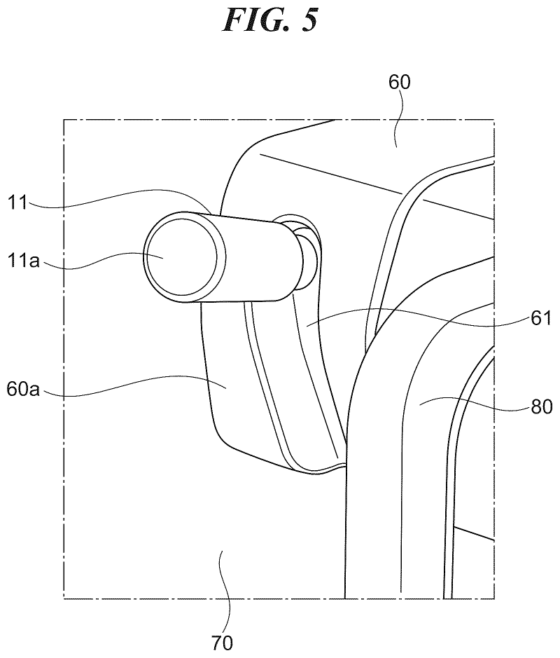

FIG. 5 is a perspective view illustrating the vicinity of the operation lever 11 in a third configuration example. FIG. 5 illustrates the operation lever 11 in the use posture, and the operation lever 11 on the way between the use posture and the non-use posture and the operation lever 11 in the non-use posture are not illustrated.

In the third configuration example, the tilting direction of the operation lever 11 and the arrangement of the storage space 61 corresponding thereto are different from those in the first configuration example (see FIGS. 3A to 3C). The operation lever 11 is rotatable substantially in the vertical direction. The storage space 61 provided on the left side face 60a of the steering column 60 is a recess capable of storing the operation lever 11.

When the operation lever 11 is stored in the storage space 61, the distance of the distal end portion 11a of the operation lever 11 from the rotation center C becomes shorter than when the operation lever 11 is in the use posture. This ensures that the operation lever 11 does not interfere with the instrument panel 70 when the steering column 60 moves to the storage position.

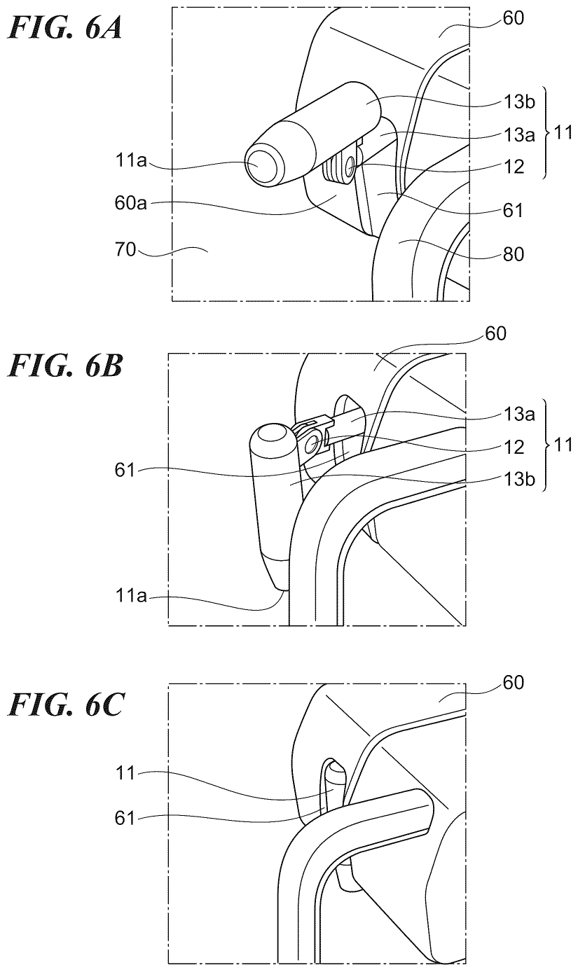

FIGS. 6A, 6B, and 6C are perspective views each illustrating the vicinity of the operation lever 11 in a fourth configuration example. FIG. 6A illustrates the operation lever 11 in the use posture, FIG. 6B illustrates the posture of the operation lever 11 on the way between the use posture and the non-use posture, and FIG. 6C illustrates the operation lever 11 in the non-use posture.

The operation lever 11 includes an advancing and retracting member 13a, a rotary member 13b, and a shaft portion 12 rotatably connecting the advancing and retracting member 13a and the rotary member 13b. The advancing and retracting member 13a is movable forward and backward in the longitudinal direction of the advancing and retracting member 13a. The rotary member 13b is rotatable relative to the advancing and retracting member 13a about the shaft portion 12.

The storage space 61 provided on the left side face 60a of the steering column 60 includes a hole capable of storing the advancing and retracting member 13a and a recess corresponding to the shape of the rotary member 13b.

Starting from the use posture (see FIG. 6A), the operation lever 11 operates such that the rotary member 13b first rotates downward (see FIG. 6B), then the advancing and retracting member 13a is retracted into the hole of the storage space 61, and the rotary member 13b enters the recess of the storage space 61 during the retraction (see FIG. 6C).

As a result, the operation lever 11 is stored in the storage space 61, and the distance of the distal end portion 11a of the operation lever 11 from the rotation center C becomes shorter than when the operation lever 11 is in the use posture. This ensures that the operation lever 11 does not interfere with the instrument panel 70 when the steering column 60 moves to the storage position. It should be noted that the temporal order of the rotation of the rotary member 13b and the retracting of the advancing and retracting member 13a is not specified.

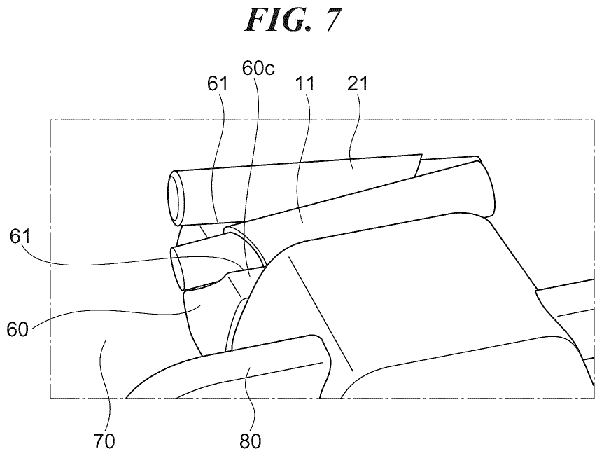

FIG. 7 is a perspective view illustrating the vicinity of the operation lever 11 in a fifth configuration example. FIG. 7 illustrates the operation levers 11 and 21 in the non-use posture, and the operation levers 11 and 21 on the way between the use posture and the non-use posture and the operation levers 11 and 21 in the non-use posture are not illustrated.

The operation levers 11 and 21 are configured to be tilted in a direction approaching the upper face 60c of the steering column 60 when shifting from the use posture to the non-use posture. The storage space 61 being a recess is provided on the upper face 60c for each of the operation levers 11 and 21. When the operation levers 11 and 21 are tilted and stored in the corresponding storage spaces 61, the distance of the distal end portions 11a and 21a of the operation levers 11 and 21 from the rotation center C becomes shorter than when the operation levers 11 and 21 are in the use posture. This ensures that the operation levers 11 and 21 do not interfere with the instrument panel 70 when the steering column 60 moves to the storage position.

It should be noted that the configuration of the steering column device 100 is not limited to the configuration examples illustrated in FIGS. 3A to 7, and the storage space 61 may be provided, for example, on the bottom face 60d of the steering column 60. Furthermore, the steering column device 100 may be configured such that, when the entire lever units 10 and 20 are in the non-use posture, the entire lever units 10 and 20 or the operation levers 11 and 21 may be tilted in a direction in which the distal end portions 11a and 21a of the operation levers 11 and 21 approach the side faces 60a and 60b, the upper face 60c, or the bottom face 60d of the steering column 60. In this configuration, the steering column 60 may not necessarily be provided with a storage space. When the operation levers 11 and 21 approach any of the faces of the steering column 60, this shortens the distance between the distal end portions 11a and 21a of the operation levers 11 and 21 from the rotation center C, whereby interference between the operation levers 11 and 21 and the instrument panel 70 can be avoided.

According to the present embodiment, the distance between the distal end positions of the operation levers 11 and 21 from the rotation center C is shorter when the lever units 10 and 20 are in the non-use posture than when the lever units 10 and 20 are in the use posture. When the steering column 60 moves from the protruding position to the storage position, the lever units 10 and 20 change from the use posture to the non-use posture. This avoids interference between the operation levers 11 and 21 and the instrument panel 70 during storage of the steering wheel 80.

### Second Embodiment

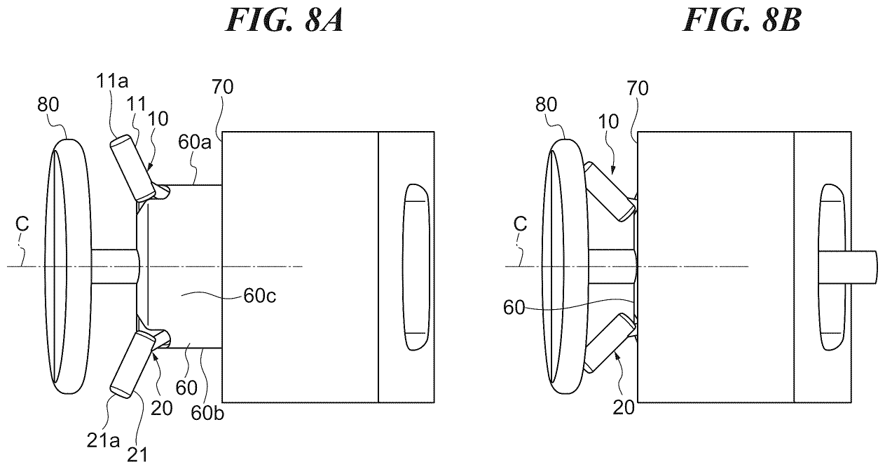

FIGS. 8A and 8B are schematic top views of a steering column device according to a second embodiment of the present disclosure. The present embodiment is different from the first embodiment in that the entire lever units 10 and 20 are tilted. Description of configurations similar to those of the first embodiment will be omitted.

In FIG. 8A, the steering column 60 is at a protruding position, and lever units 10 and 20 are in a use posture. In FIG. 8B, the steering column 60 is at a storage position, and the lever units 10 and 20 are in a non-use posture.

When the lever units 10 and 20 are in the non-use posture (see FIG. 8B), the entire lever units 10 and 20 are tilted in a direction in which the distal end portions 11a and 21a of the operation levers 11 and 21 approach the steering wheel 80. This avoids interference between the operation levers 11 and 21 and the instrument panel 70. It should be noted that also in the present embodiment, the distance of the distal end portions 11a and 21a of the operation levers 11 and 21 from the rotation center C in the non-use posture is shorter when the lever units 10 and 20 are in the non-use posture than when the lever units 10 and 20 are in the use posture.

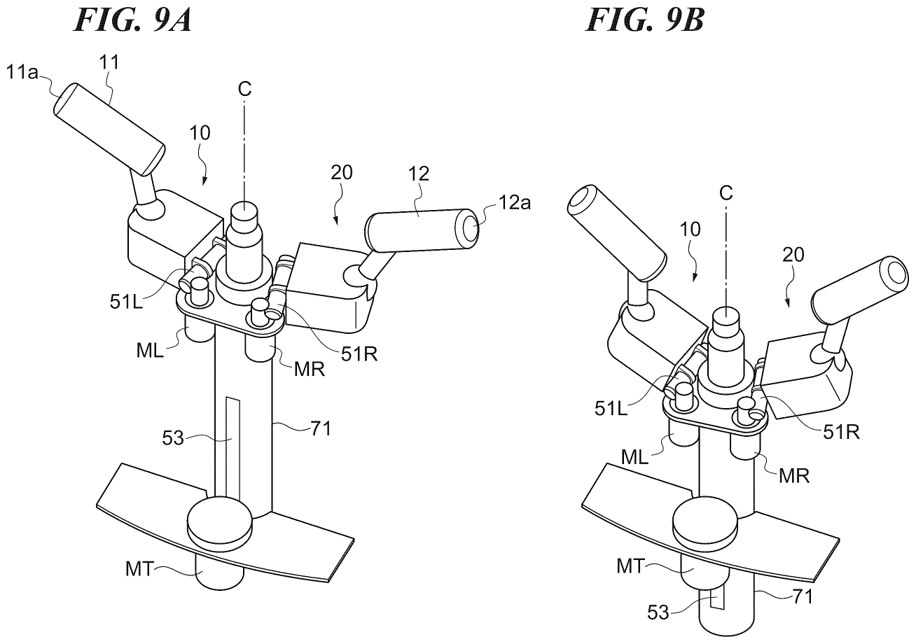

Referring to FIGS. 9A to 12B, a description is given of configuration examples of the steering column device 100 in which interference between the operation levers 11 and 21 and the instrument panel 70 is avoided by the entire lever units 10 and 20 being tilted to be in the non-use posture. The steering column device 100 may adopt any of these configuration examples. Posture changes of the lever unit 10 and the lever unit 20 are bilaterally symmetrical.

FIGS. 9A and 9B correspond to FIGS. 8A and 8B, and are perspective views each illustrating the vicinity of the lever units 10 and 20 in a sixth configuration example.

As illustrated in FIG. 9A, a motor MT is fixed to the vehicle. A support column 71 is disposed movably in the axial direction of the rotation center C relative to the vehicle. The support column 71 is provided with a rack gear 53 that meshes with a worm gear connected to an output shaft of the motor MT. The support column 71 moves in the axial direction of the rotation center C by the rotation of the motor MT.

The lever units 10 and 20 are movable integrally with the support column 71 in the axial direction of the rotation center C. The lever units 10 and 20 are rotatable relative to the support column 71 in generally clockwise and counterclockwise directions in FIG. 8A. That is, the lever units 10 and 20 are rotatable in a direction in which the distal end portions 11a and 21a of the operation levers 11 and 21 approach the steering wheel 80 and the rotation center C and a direction in which the distal end portions 11a and 21a are separated from the steering wheel 80 and the rotation center C.

Motors ML and MR are fixed to the support column 71. The lever units 10 and 20 include transmission units 51L and 51R, respectively. Worm gears provided in the motors ML and MR mesh with worm wheels provided in the transmission units 51L and 51R, respectively, which converts the rotation of the motors ML and MR into the rotation of the lever units 10 and 20.

Regarding a correspondence between the configuration of the present embodiment and the configuration illustrated in FIG. 2, the motor MT corresponds to the column drive unit 32, and the motors ML and MR correspond to the lever drive unit 33.

In response to acquisition of an instruction to move the steering column 60 to the storage position, the control unit 31 controls the motor MT to move the steering column 60 to the storage position (see FIG. 9B). At that time, the control unit 31 controls the motors ML and MR to tilt the lever units 10 and 20 to change to the non-use posture (see FIG. 9B).

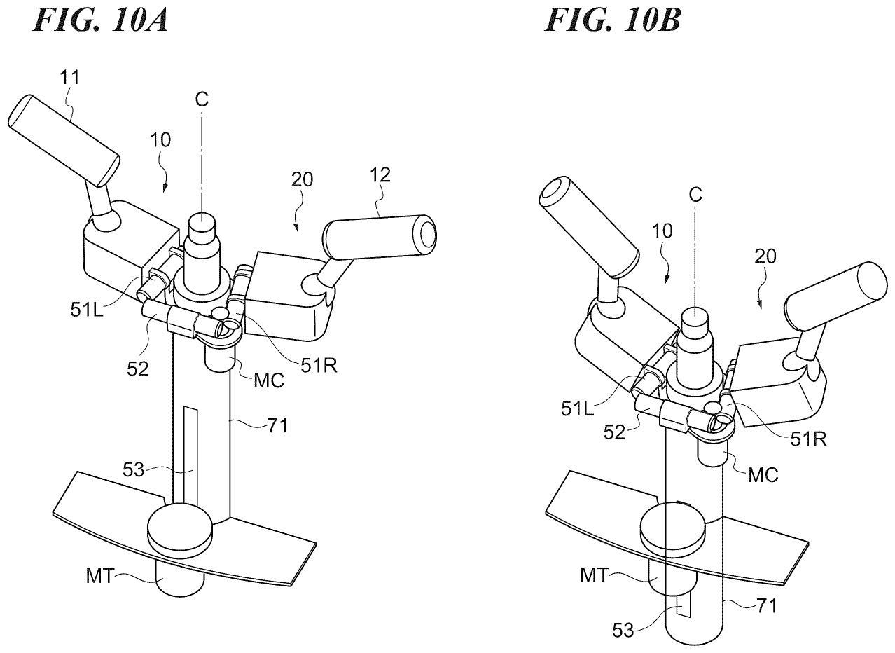

FIGS. 10A and 10B correspond to FIGS. 8A and 8B, and are perspective views each illustrating the vicinity of the lever units 10 and 20 in a seventh configuration example.

The seventh configuration example is different from the sixth configuration example in that a single motor MC is provided instead of the motors ML and MR as a component corresponding to the lever drive unit 33. Further, an intermediate transmission unit 52 for transmitting the output of the motor MC to the transmission units 51L and 51R is provided.

The output of the motor MC is converted into the rotation of the lever unit 20 via the intermediate transmission unit 52 and the transmission unit 51R. The output of the motor MC is converted into the rotation of the lever unit 10 via the intermediate transmission unit 52 and the transmission unit 51L. The operation of the steering column 60 and the tilting operation of the lever units 10 and 20 are similar to those in the sixth configuration example. In the seventh configuration example, since both the left and right lever units 10 and 20 can be driven by the one motor MC, the configuration is simplified and contributes to cost reduction.

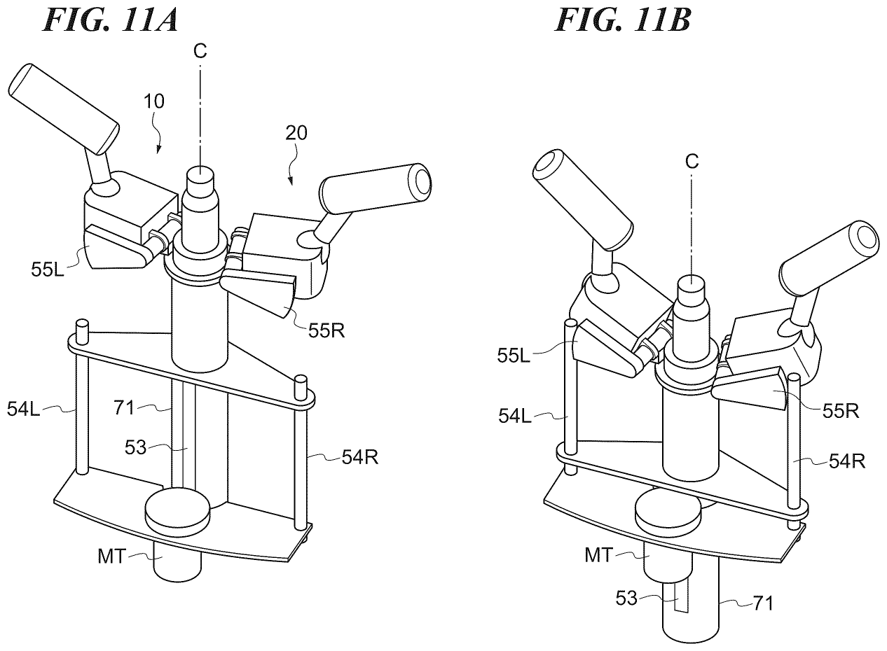

FIGS. 11A and 11B correspond to FIGS. 8A and 8B, and are perspective views each illustrating the vicinity of the lever units 10 and 20 in an eighth configuration example.

In the eighth configuration example, the column drive unit 32 (motor MT) also serves as the lever drive unit 33 (see FIG. 2). A first members 54L and 54R are fixed relative to the vehicle or the instrument panel 70. The first members 54L and 54R are shafts parallel to the axial direction of the rotation center C. Rack gears are formed in the vicinity of the distal ends of the first members 54L and 54R.

A second members 55L and 55R are fixed to the lever units 10 and 20, respectively. Pinion gears are formed on the second members 55L and 55R, and the pinion gears can mesh with the respective rack gears of the first members 54L and 54R.

During the movement of the support column 71 from the protruding position to the storage position by the rotation of the motor MT, the rack gears of the first members 54L and 54R mesh with the respective pinion gears of the second members 55L and 55R, thereby driving the second members 55L and 55R. This causes the lever units 10 and 20 to rotate in conjunction with the movement of the support column 71 and to change to the non-use posture (see FIG. 11B).

Since the motor MT also serves as the lever drive unit 33 that rotates the lever units 10 and 20, the configuration of the steering column device 100 is simplified, which contributes to cost reduction.

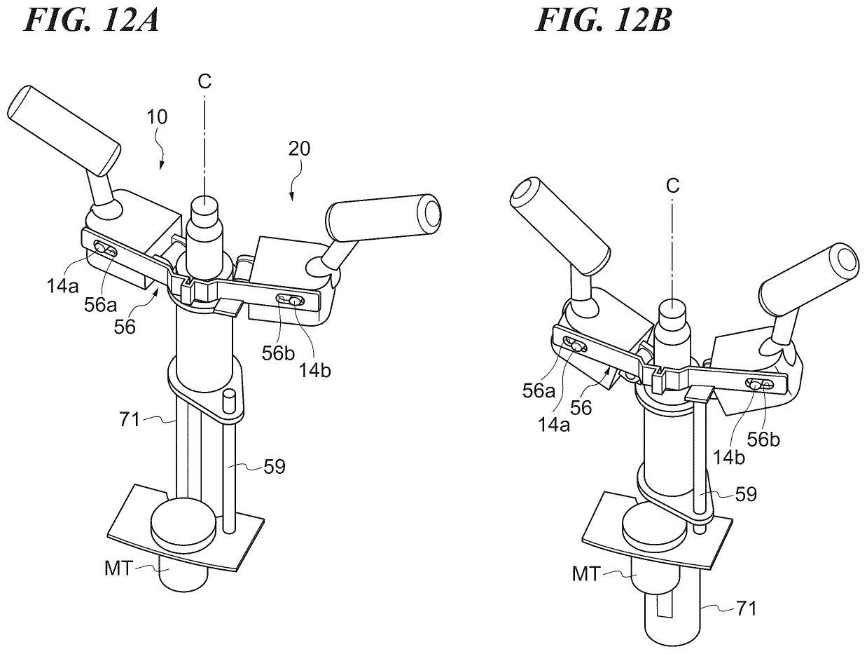

FIGS. 12A and 12B correspond to FIGS. 8A and 8B, and are perspective views each illustrating the vicinity of the lever units 10 and 20 in a ninth configuration example.

The ninth configuration example is different from the eighth configuration example (see FIGS. 11A and 11B) in that one first member 59 is provided instead of the first members 54L and 54R, and a second member 56 is provided instead of the second members 55L and 55R. Note, however, that the first member 59 does not need to have a rack gear, and is a push-up shaft in this configuration example. The second member 56 is not fixed to the lever units 10 and 20, but is engaged with the lever units 10 and 20.

First, the lever units 10 and 20 are provided with engagement pins 14a and 14b, respectively. The second member 56 is a slotted plate with long holes 56a and 56b. The engagement pins 14a and 14b are engaged with the long holes 56a and 56b, respectively.

During the movement of the support column 71 from the protruding position to the storage position by the rotation of the motor MT, the first member 59 abuts against the second member 56, and thus the second member 56 cannot move together with the support column 71. That is, since the second member 56 moves relative to the support column 71, the engagement positions of the engagement pins 14a and 14b in the respective long holes 56a and 56b change in a direction approaching the rotation center C. On the other hand, the rotation center positions of the lever units 10 and 20 relative to the support column 71 do not change. As a result, the lever units 10 and 20 tilt in the direction of their non-use posture. Therefore, the lever units 10 and 20 rotate in conjunction with the movement of the support column 71 to change to the non-use posture (see FIG. 11B).

In the ninth configuration example, the motor MT also serves as the lever drive unit 33 that rotates the lever units 10 and 20. Furthermore, only one first member 59 is used in this configuration example. Consequently, the configuration becomes simple and cost is reduced.

According to the present embodiment, it is possible to achieve an effect similar to that of the first embodiment regarding avoidance of interference between the operation levers 11 and 21 and the instrument panel 70 during storage of the steering wheel 80.

In the present embodiment, the column drive unit 32 also serves as an adjuster that adjusts the position of the steering wheel 80 in the axial direction of the rotation center C while the position of the steering wheel 80 is within a predetermined range. It should be noted that the column drive unit 32 does not necessarily serve as the adjuster. Instead, a mechanism for moving the steering column 60 forward and backward between the protruding position and the storage position and a mechanism for adjusting the position of the steering wheel 80 within the predetermined range may be provided separately.

As exemplified below, a configuration that restricts the movement of the lever units 10 and 20 while the position of the steering wheel 80 is within the predetermined range may be adopted. Examples in which such a configuration is applied to the eighth configuration example (FIGS. 11A and 11B) and the ninth configuration example (FIGS. 12A and 12B) will be described as representatives.

For example, in the case of the eighth configuration example or the ninth configuration example, the driving force (holding force) from the column drive unit 32 is not transmitted to the lever units 10 and 20 while the position of the steering wheel 80 is within the predetermined range. Thus, the holding force of the lever units 10 and 20 may be insufficient, resulting in an unintended change in the posture of the lever units 10 and 20. As a countermeasure, the configuration may include the lock member 38 and the lock drive unit 35 (see FIG. 2) to provide supplemental holding force.

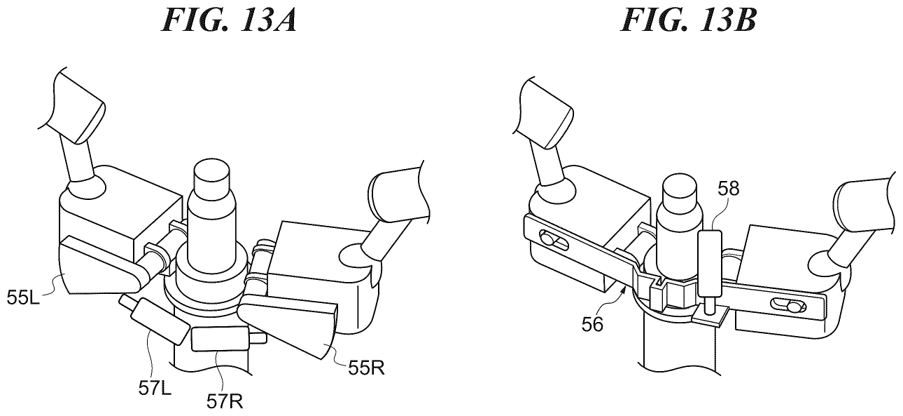

FIG. 13A is an enlarged perspective view of the vicinity of second members 55L and 55R in the eighth configuration example (see FIGS. 11A and 11B).

Lock pins 57L and 57R are disposed close to the second members 55L and 55R, respectively. The lock pins 57L and 57R are fixed to the support column 71. The lock pins 57L and 57R correspond to the lock member 38 (see FIG. 2).

When the lock pins 57L and 57R protrude by a predetermined amount, the second members 55L and 55R are secured. That is, the lever units 10 and 20 is secured by the lock pins 57L and 57R, respectively.

The control unit 31 controls the lock drive unit 35 to operate the lock pins 57L and 57R so as to hold the second members 55L and 55R in a state where the position of the steering wheel 80 is within the predetermined range.

FIG. 13B is an enlarged perspective view of the vicinity of the second member 56 in the ninth configuration example (see FIGS. 12A and 12B). A lock pin 58 is disposed close to the second member 56. The lock pin 58 is fixed to the support column 71. The lock pin 58 corresponds to the lock member 38 (see FIG. 2).

When the lock pin 58 protrudes by a predetermined amount, the second member 56 is secured. That is, the lever units 10 and 20 is secured by the lock pin 58.

The control unit 31 controls the lock drive unit 35 to operate the lock pin 58 so as to hold the second member 56 while the position of the steering wheel 80 is within the predetermined range.

The configuration illustrated in FIGS. 13A and 13B avoids vibration of the lever units 10 and 20 and an unintended change in the postures of the lever units 10 and 20 while the position of the steering wheel 80 is within the predetermined range.

It should be noted that such a configuration of providing the lock member 38 may also be applied to other configuration examples of the steering column device 100. It should be noted that the lock member 38 may be disposed at a position other than the support column 71, as long as the lock member 38 can hold the lever units 10. For example, in a state where the lock member 38 is disposed on the lever units 10 and 20 and the position of the steering wheel 80 is within the predetermined range, the lever units 10 and 20 may be held by the lock member 38 engaging with the support column 71.

It should be noted that the movement of the lever units 10 and 20 is preferably started prior to the movement of the steering column 60 to the storage position, but this is not essential. The lever units 10 and 20 may start moving at a timing at which the lever units 10 and 20 can avoid interference with the instrument panel 70.

Although the present disclosure has been described in detail on the basis of preferred embodiments thereof, the present technology is not limited to these specific embodiments, and various forms not departing from the gist of the present technology are also included in the present technology. Parts of the above-described embodiments may be appropriately combined.

This application claims the benefit of Japanese Patent Application No. 2025-42533 filed on Mar. 17, 2025 which is hereby incorporated by reference herein in its entirety.

What is claimed is:

1. A steering column device comprising:
a steering column movable forward and backward between a protruding position and a storage position relative to an instrument panel; and
a lever unit provided on the steering column, including an operation lever, and configured to change a posture relative to the steering column between a use posture and a non-use posture,
wherein a distance of a distal end position of the operation lever from a rotation center of a steering wheel is shorter when the lever unit is in the non-use posture than when the lever unit is in the use posture, and
when the steering column moves from the protruding position to the storage position, the lever unit changes from the use posture to the non-use posture to avoid interference between the operation lever and the instrument panel.

2. The steering column device according to claim 1, further comprising:
a lever drive unit that changes a posture of the lever unit by driving at least a part of the lever unit; and
a control unit that controls the lever drive unit to change the lever unit to the non-use posture in response to acquisition of an instruction to move the steering column to the storage position.

3. The steering column device according to claim 2, further comprising a storage space provided in the steering column,
wherein when the lever unit is in the non-use posture, at least a part of the operation lever is stored in the storage space.

4. The steering column device according to claim 2,
wherein when the lever unit is in the non-use posture, an entire lever unit or the operation lever is tilted in a direction in which the distal end portion of the operation lever approaches a side face, an upper face, or a bottom face of the steering column.

5. The steering column device according to claim 2,
wherein when the lever unit is in the non-use posture, an entire lever unit is tilted in a direction in which the distal end portion of the operation lever approaches the steering wheel.

6. The steering column device according to claim 5,
wherein a left lever unit and a right lever unit provided as the lever units on the steering column are driven by the lever drive unit including one motor.

7. The steering column device according to claim 5, further comprising
a column drive unit that moves the steering column forward or backward,
wherein the column drive unit also serves as the lever drive unit.

8. The steering column device according to claim 7, further comprising:
a first member fixed relative to the instrument panel; and
a second member fixed to or engaged with the lever unit,
wherein during movement of the steering column toward the storage position by the column drive unit, the first member drives the second member to change the posture of the lever unit.

9. The steering column device according to claim 7,
wherein the column drive unit also serves as an adjuster that adjusts a position of the steering wheel in an axial direction of the rotation center while the position of the steering wheel is within a predetermined range, and
the driving force from the column drive unit is not transmitted to the lever unit while the position of the steering wheel is within the predetermined range.

10. The steering column device according to claim 9, further comprising a lock member that holds the lever unit while the position of the steering wheel is within the predetermined range.

11. The steering column device according to claim 8,
wherein the column drive unit also serves as an adjuster that adjusts a position of the steering wheel in an axial direction of the rotation center while the position of the steering wheel is within a predetermined range, and
the driving force from the column drive unit is not transmitted to the lever unit while the position of the steering wheel is within the predetermined range.

12. The steering column device according to claim 11, further comprising a lock member that holds the lever unit while the position of the steering wheel is within the predetermined range.
